(19) United States
(12) Patent Application Publication
(10) Pub. No.: US 2009/0262479 A1
(43) Pub. Date: Oct. 22, 2009

(54) Electromagnetic actuating device being actuated by high voltage and held electrification by low voltage

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/081,714

(22) Filed: Apr. 21, 2008

(51) Int. Cl. H01H 47/22

(52) U.S. Cl. 361/154

(57) ABSTRACT

The present invention is disclosed by that the power source device with variable output voltage is operatively controlled by the switching device to provide higher voltage power to the driving coil installed in the electromagnetic actuating device so as to produce larger electromagnetic effective force, wherein the power source device with variable output voltage after actuation is operatively controlled by the switching device to be switched to provide lower voltage power thus allowing smaller current to pass through the driving coil thereby holding electrification for excitation, while required operating characteristics of the electromagnetic actuating device can still be ensured.

### BACKGROUND OF THE INVENTION

(a) Field of the Invention

The present invention is mainly related to the electromagnetic actuating device installed with a DC or AC driving coil being electrified to produce electromagnetic actuating effect, wherein the power source device with variable output voltage being operatively controlled by the switching device to electrify the driving coil installed in the electromagnetic actuating device by higher voltage power input, wherein after electromagnetic actuating device is actuated, the power source device is further operatively controlled by the switching device to be switched to provide lower voltage power to the driving coil thereby holding electrification for excitation thus reducing total current passing through the driving coil while required operating characteristics of the electrified electromagnetic actuating device are still satisfied thereby saving electric power and reducing heat loss.

(b) Description of the Prior Art

For conventional electromagnetic actuating devices driven by supplying DC or AC power to driving coils for producing electromagnetic actuating effect, if the coil electrification power remains unchanged when the electrification status is actuated and held, the current for holding electrification is larger, therefore it has the disadvantages of high heat loss and wasting electric energy.

### SUMMARY OF THE INVENTION

The present invention discloses an electromagnetic actuating device being actuated by high voltage and held electrification by low voltage, wherein the DC or AC driving coil installed in the electromagnetic actuating device is operatively controlled by the switching device, wherein it includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the power source device with variable output voltage is operatively controlled by the switching device to electrify the driving coil installed in the electromagnetic actuating device by higher voltage power input to produce a larger electromagnetic actuating force on the electromagnetic actuating device, wherein after the electromagnetic actuating device is actuated, the power source device is further operatively controlled by the switching device to be switched to provide lower voltage power to the driving coil thereby holding electrification for excitation thus reducing total current passing through the driving coil while required operating characteristics of the electrified electromagnetic actuating device are still satisfied by the electromagnetic effective force thereby saving electric power and reducing heat loss.

### BRIEF DESCRIPTION OF THE DRAWINGS

FIG. 1 is a circuit-block schematic view of the embodiment of the present invention showing that the electromagnetic actuating device with a driving coil is actuated by high voltage and held electrification by low voltage.

FIG. 2 is a circuit schematic view showing the electrification by higher voltage DC or AC power input in the embodiment of FIG. 1.

FIG. 3 is a circuit schematic view showing that lower voltage DC or AC power input is supplied to the driving coil for holding electrification in the embodiment of FIG. 1.

FIG. 4 is a circuit-block schematic view showing that the electromagnetic actuating device is installed with a position detector device to operatively control the excitation power to the driving coil.

### DESCRIPTION OF MAIN COMPONENT SYMBOLS

100: Power source device with variable output voltage
101: Switching device
102: Electromagnetic actuating device
103: AC surge absorption device
105: Position detector device
113: DC surge absorption device
123: General type surge absorption device
102′: Driving coil
Ia: Larger excited current
Ib: Smaller holding current
VH: Higher voltage DC or AC power
VIN: DC or AC voltage
VL: Lower voltage DC or AC power

### DETAILED DESCRIPTION OF THE PREFERRED EMBODIMENTS

The present invention discloses that an electromagnetic actuating device with a DC or AC driving coil is operatively controlled by the switching device, wherein it includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the power source device with variable output voltage is operatively controlled by the switching device to electrify the driving coil installed in the electromagnetic actuating device by higher voltage power input to produce a larger electromagnetic actuating force on the electromagnetic actuating device, wherein after the electromagnetic actuating device is actuated, the power source device is further operatively controlled by the switching device to be switched to provide lower voltage power to the driving coil thereby holding electrification for excitation thus reducing total current passing through the driving coil while required operating characteristics of the electrified electromagnetic actuating device are still satisfied thereby saving electric power and reducing heat loss.

The embodiments of the electromagnetic actuating device with a driving coil are described in the following:

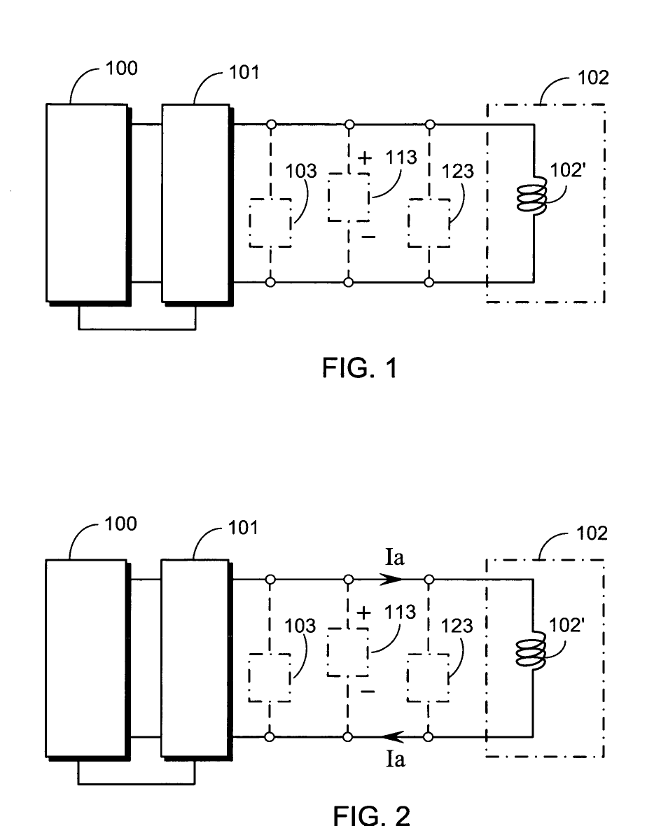

FIG. 1 is a circuit-block schematic view of the embodiment of the present invention showing that the electromagnetic actuating device with a driving coil is actuated by high voltage and held electrification by low voltage, wherein it mainly comprises:

A power source device with variable output voltage (100): related to a power source supply device (100) with variable output voltage constituted by electrical machineries, electronic components, or power source supply devices containing microprocessor and relevant software with relevant power supply functions as well as voltage and current control functions, wherein its input end is for receiving DC or AC power (VIN) to be operatively controlled by the switching device (101) to provide higher voltage DC or AC power output (VH), or lower voltage DC or AC power output (VL), or DC power output of semi-wave or full waved or chopped wave, etc., wherein the voltage relationships between DC or AC input voltage (VIN) at input end of the power source device (100) with variable output voltage, higher voltage DC or AC power output (VH) and lower voltage DC or AC power output (VL) include:

(1) VIN>VH>VL; or

(2) VH>VIN>VL; or

(3) VH>VL>VIN; or

(4) VIN=VH>VL; or

(5) VH>VIN=VL;

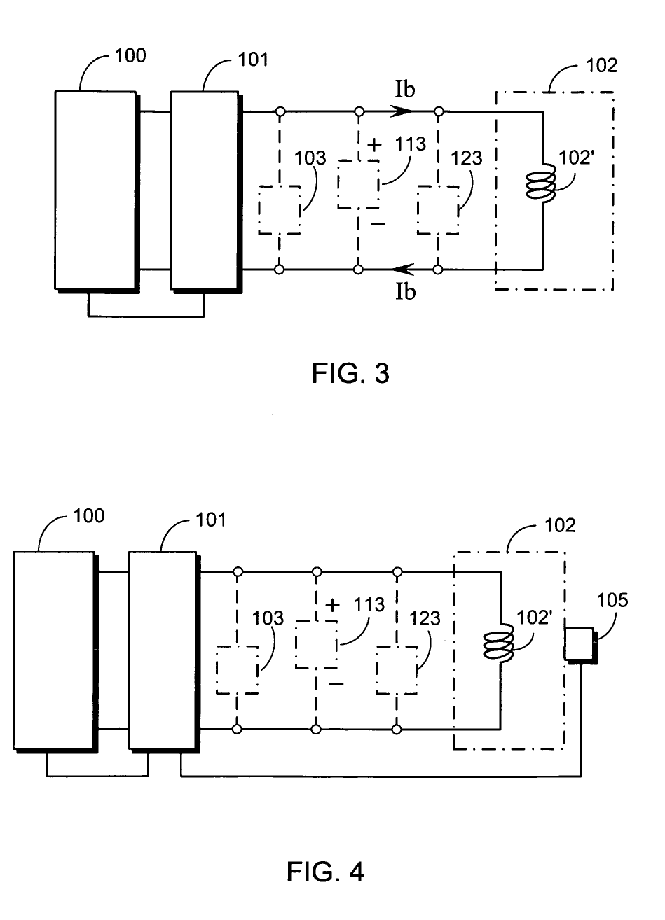

A switching device (101): It is constituted by an electromechanical switch, an electric relay, an electromagnetic switch or a solid state switching device, etc. operable by the manual, mechanical, fluid or electrical power being operated by the manual, mechanical, fluid or electrical power for supply DC or AC power to the driving coil (102′) of the electromagnetic actuating device (102) to provide the switching function for electrification and power cut-off, or it is through the switchover operation by the switching device (101) to electrify the driving coil (102′) installed in the electromagnetic actuating device by higher voltage DC or AC power (VH) from the power source device (100) thereby allowing the larger excited current (Ia) to pass through the driving coil. FIG. 2 is a circuit schematic view showing the electrification by higher voltage DC or AC power (VH) input in the embodiment of FIG. 1, wherein the driving coil (102′) being actuated for excitation by higher voltage DC or AC power input is operatively controlled by the switching device (101) to be switched to allow the power source device of variable output voltage (100) to supply lower voltage DC or AC power (VL) input to the driving coil (102′) thus allowing smaller excited current (Ia) to pass through the driving coil (102′) thereby holding electrification for excitation. FIG. 3 is a circuit schematic view showing that lower voltage DC or AC power (VL) input is supplied to the driving coil for holding electrification in the embodiment of FIG. 1, wherein when lower voltage DC or AC power (VL) input is supplied to the driving coil (102′) for holding electrification, total current on the driving coil is reduced, while operating characteristics of the electrified electromagnetic actuating device is still ensured by the electromagnetic effective force, thereby saving electric power and reducing heat generation in the electromagnetic actuating device.

For the electromagnetic actuating device being actuated by high voltage and held electrification by lower voltage, after the driving coil (102′) installed in the electromagnetic actuating device (102) is electrified for excitation by high voltage DC or AC power (VH) input, DC or AC power output from the power source device with variable output voltage (100) being operatively controlled by the switching device (101) is switched to lower voltage DC or AC power (VL) output for supplying input to the driving coil (102′) to hold electrification for excitation, wherein the switching methods include:

(1) The power of the power source device with variable output voltage (100) for supplying to the driving coil (102′) being operatively controlled by a manual-sequential operating switching device (101) is switched from providing higher voltage DC or AC power (VH) input to electrically actuate the driving coil for excitation to lower voltage DC or AC power (VL) input thereby holding electrification for excitation; or

(2) The power of the power source device with variable output voltage (100) for supplying to the driving coil (102′) being operatively controlled by the switching device (101) is switched with a time delay function from providing higher voltage DC or AC power (VH) input to electrically actuate the driving coil for excitation to lower voltage DC or AC power (VL) input thereby holding electrification for excitation after a time delay; or

(3) By detecting the current value passing through the switching device (101) to the driving coil (102′), when the excited current value of the driving coil (102′) of the electromagnetic actuating device (102) to be electrically actuated by the higher voltage DC or AC power (VH) output of the power source device with variable output voltage (100) □ the setting current value, or □ the status of setting current value exceeding over the setting time, the switching device (101) being driven to operatively control the power of the power source device (100) with variable output voltage for supplying to the driving coil (102′) is switched to lower voltage DC or AC power (VL) output for supplying to the driving coil (102′) thereby holding electrification for excitation; or

(4) The switching device (101) is operatively controlled by two or more than two methods of the above said (1) (2) (3);

The electromagnetic actuating devices (102): It is the device installed with an AC or DC powered driving coil (102′) including conventional normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the power source device with variable output voltage (100) is operatively controlled by the switching device (101) to electrify the driving coil (102′) of the electromagnetic actuating device (102) by higher voltage power (VH) input, wherein after the electromagnetic actuating device is actuated, the power source device with variable output voltage (100) is further switched to provide lower voltage DC or AC power (VL) to the driving coil (102′) thereby holding electrification for excitation thereby saving power and reducing heat generation; while when the driving coil (102′) of electromagnetic actuating device (102) is supplied by lower voltage DC or AC power (VL) input to hold electrification for excitation, required operating characteristics of the electrified electromagnetic actuating device are still satisfied by the electromagnetic effective force thereby saving electric power and reducing heat loss;

The AC surge absorption device (103), DC surge absorption device (113), general type surge absorption device (123): The AC surge absorption device (103), DC surge absorption device (113) or general type surge absorption device (123) being optionally installed to parallel connect with the driving coil based on input power types to electromagnetic actuating device (102) is used to help absorbing the produced inductance of counter-electric potential in the driving coil (102′), when the driving coil (102′) is operated by the switching device (101) to open or close, or to receive higher voltage DC or AC power (VH) for electrifying the driving coil (102′), or to be switched to provide lower voltage DC or AC power (VL) output to the driving coil (102′) for holding excitation, wherein AC or DC power input to the driving coil (102′) can be respectively matchingly optionally connected with the AC surge absorption device (103), DC surge absorption device (113), or general type surge absorption device (123); wherein the surge absorption device is optionally constituted by the following: (1) When the driving coil (102′) is powered by AC power, the AC surge absorption device (103) is installed, such as that it can be constituted by a bipolar solid state varistor, or constituted by at least two kinds of components of the resistors, inductors, bipolar capacitors, etc. in series connection, parallel connection, or series-parallel connection, or constituted by the bipolar capacitor alone, or constituted by other conventional AC surge absorption circuit devices; (2) When the driving coil (102′) is powered by DC power, the DC surge absorption device (113) is installed, such as that it can be constituted by reverse polarity diodes in parallel connection to appear a flywheel diode with energy storage effect, or constituted by at least two kinds of components of the resistors, inductors, uni-polar or bipolar capacitors in series connection, parallel connection, or series-parallel connection, or constituted by the uni-polar or bipolar capacitor alone, or constituted by the solid state varistor or other conventional DC surge absorption devices; (3) When the driving coil (102′) is powered by mixture of AC and DC power, the general type surge absorption device (123) capable of absorbing either AC surge power or DC surge power is installed, such as that it can be constituted by at least two kinds of components of the resistors, inductors or bipolar capacitors in series connection, parallel connection, or series-parallel connection, or constituted by the bipolar capacitor alone, or constituted by bipolar solid state varistor or other conventional general type surge absorption devices; wherein this device can be optionally installed or not installed as required.

For the electromagnetic actuating device being actuated by high voltage and held electrification by low voltage, the driving coil (102′) of the electromagnetic actuating device being supplied by higher voltage DC or AC power (VH) input to be electrically actuated for excitation is switched to supply lower voltage DC or AC power (VL) to the driving coil (102′) thereby hold electrification for excitation, wherein the switching method is further shown in FIG. 4 which is a circuit-block schematic view showing that the electromagnetic actuating device is installed with a position detector device to operatively control the excitation power to the driving coil; wherein the position detector device (105) is installed at a stable position after relative actuation between the rotor and the stator of the electromagnetic actuating device or at a selected position in the stroke of actuation, so that the driving coil (102′) of the electromagnetic actuating device (102) being supplied by higher voltage DC or AC power (VH) to be driven to the stable position or the selected position in the stroke of actuation is through the position detector device (105) to directly switch the power source device with variable output voltage (100) to provide lower voltage DC or AC power (VL) output to the driving coil (102′) thereby holding electrification for excitation; or the driving coil (102′) being supplied by higher voltage DC or AC power (VH) to be driven to a stable position or a selected position in the stroke of actuation is operatively controlled by the switching device (101) being operatively controlled by the position detector device (105) to be switched to allow the power source device with variable output voltage (100) to provide lower voltage DC or AC power (VL) to the driving coil (102′) thereby holding electrification for excitation;

The position detector device (105) can be constituted by pressure sensing type electromechanical switching devices or pressure-actuating spring leaf type switches, or can be constituted by optical, electromagnetic inducing type, capacitive inducing type or other conventional position sensing devices, wherein this device can be optionally installed or not installed as required.

As summarized from the above descriptions, the electromagnetic actuating device being actuated by high voltage and held electrification by lower voltage can be through the power source device with variable output voltage (100) being operatively controlled by the switching device (101) to provide higher voltage DC or AC power (VH) to electrify the driving coil (102′) for excitation so as to obtain the larger electromagnetic effective force on the electromagnetic actuating device, wherein it is operatively controlled by the switching device (101) after actuation to be switched to allow the power source device with variable output voltage (100) to provide lower voltage DC or AC power (VL) to the driving coil (102′) thus holding electrification for excitation thereby reducing total current passing through the driving coil (102′), while required operating characteristics of the electrified electromagnetic actuating device can still be satisfied by the electromagnetic effective force thereby saving electric power and reducing heat loss.

1. An electromagnetic actuating device being actuated by high voltage and held electrification by low voltage is through the power source device with variable output voltage being operatively controlled by the switching device to provide higher voltage power to the driving coil installed in the electromagnetic actuating device so as to produce larger electromagnetic effective force on the electromagnetic actuating device, wherein after the electromagnetic actuating device is actuated, the power source device is further operatively controlled by the switching device to be switched to provide lower voltage power to the driving coil thereby holding electrification for excitation thus reducing total current passing through the driving coil while required operating characteristics of the electrified electromagnetic actuating device are still satisfied by the electromagnetic effective force thereby saving electric power and reducing heat loss; it essentially comprises:
A power source device with variable output voltage (100): related to a power source supply device (100) with variable output voltage constituted by electrical machineries, electronic components, or power source supply devices containing microprocessor and relevant software with relevant power supply functions as well as voltage and current control functions, wherein its input end is for receiving DC or AC power (VIN) to be operatively controlled by the switching device (101) to provide higher voltage DC or AC power output, or lower voltage DC or AC power output (VL), or DC power output of semi-wave or full waved or chopped wave, etc., wherein the voltage relationships between DC or AC input voltage (VIN) at input end of the power source device (100) with variable output voltage, higher voltage DC or AC power output (VH) and lower voltage DC or AC power output (VL) include:
(1) (VIN)>(VH)>(VL); or
(2) (VH)>(VIN)>(VL); or
(3) (VH)>(VL)>(VIN); or
(4) (VIN)=(VH)>(VL); or
(5) (VH)>(VIN)=(VL);
A switching device (101): it is constituted by an electromechanical switch, an electric relay, an electromagnetic switch or a solid state switching device, etc. operable by the manual, mechanical, fluid or electrical power being operated by the manual, mechanical, fluid or electrical power for supplying DC or AC power to the driving coil (102′) of the electromagnetic actuating device (102) to provide the switching function for electrification and power cut-off, or it is through the switchover operation by the switching device (101) to electrify the driving coil (102′) installed in the electromagnetic actuating device by higher voltage DC or AC power (VH) from the power source device (100) thereby allowing the larger excited current (Ia) to pass through the driving coil; wherein the driving coil (102′) being actuated for excitation by higher voltage DC or AC power input is operatively controlled by the switching device (101) to be switched to allow the power source device of variable output voltage (100) to supply lower voltage DC or AC power (VL) input to the driving coil (102′) thus allowing smaller excited current (Ia) to pass through the driving coil (102′) thereby holding electrification for excitation; when lower voltage DC or AC power (VL) input is supplied to the driving coil (102′) for holding electrification, total current on the driving coil is reduced, while operating characteristics of the electrified electromagnetic actuating device is still ensured by the electromagnetic effective force, thereby saving electric power and reducing heat generation in the electromagnetic actuating device;
The electromagnetic actuating devices (102): it is the device installed with a AC or DC powered driving coil (102′) for electromagnetic driving effects, or operating type electromagnetic actuating devices which can be driven by driving coils or operated by numerous manual or mechanical power methods; wherein the power source device with variable output voltage (100) is operatively controlled by the switching device (101) to electrify the driving coil (102′) installed in the electromagnetic actuating device (102) by higher voltage power (VH) input, wherein after the electromagnetic actuating device is actuated, the power source device with variable output voltage (100) is further switched to provide lower voltage DC or AC power (VL) to the driving coil (102′) thereby holding electrification for excitation thereby saving power and reducing heat generation; while when the driving coil (102′) installed in the electromagnetic actuating device (102) is supplied by lower voltage DC or AC power (VL) input to hold electrification for excitation, required operating characteristics of the electrified electromagnetic actuating device are still satisfied by the electromagnetic effective force thereby saving electric power and reducing heat loss.

2. The electromagnetic actuating device being actuated by high voltage and held electrification by low voltage as claimed in claim 1, wherein when after the driving coil (102′) installed in the electromagnetic actuating device (102) is electrified for excitation by high voltage DC or AC power (VH) input, DC or AC power output from the power source device with variable output voltage (100) being operatively controlled by the switching device (101) is switched to lower voltage DC or AC power (VL) output for supplying input to the driving coil (102′) to hold electrification for excitation, wherein the switching methods include:
(1) The power of the power source device with variable output voltage (100) for supplying to the driving coil (102′) being operatively controlled by a manual-sequential operating switching device (101) is switched from providing higher voltage DC or AC power (VH) input to electrically actuate the driving coil for excitation to lower voltage DC or AC power (VL) input thereby holding electrification for excitation; or
(2) The power of the power source device with variable output voltage (100) for supplying to the driving coil (102′) being operatively controlled by the switching device (101) is switched with a time delay function from providing higher voltage DC or AC power (VH) input to electrically actuate the driving coil for excitation to lower voltage DC or AC power (VL) input thereby holding electrification for excitation after a time delay; or
(3) By detecting the current value passing through the switching device (101) to the driving coil (102′), when the excited current value of the driving coil (102′) of the electromagnetic actuating device (102) to be electrically actuated by the higher voltage DC or AC power (VH) output of the power source device with variable output voltage (100) □ the setting current value, or □ the status of setting current value exceeding over the setting time, the switching device (101) being driven to operatively control the power of the power source device (100) with variable output voltage for supplying to the driving coil (102′) is switched to lower voltage DC or AC power (VL) output for supplying to the driving coil (102′) thereby holding electrification for excitation; or
(4) The switching device (101) is operatively controlled by two or more than two methods of the above said (1) (2) (3).

3. The electromagnetic actuating device being actuated by high voltage and held electrification by lower voltage as claimed in claim 1, wherein the driving coil (102′) of the electromagnetic actuating device being supplied by higher voltage DC or AC power (VH) input to be electrically actuated for excitation is switched to supply lower voltage DC or AC power (VL) to the driving coil (102′) thereby hold electrification for excitation, wherein the switching methods further include the position detector device (105) is installed at a stable position after relative actuation between the rotor and the stator of the electromagnetic actuating device or at a selected position in the stroke of actuation, so that the driving coil (102′) installed in the electromagnetic actuating device (102) being supplied by higher voltage DC or AC power (VH) to be driven to the stable position or the selected position in the stroke of actuation is through the position detector device (105) to directly switch the power source device with variable output voltage (100) to provide lower voltage DC or AC power (VL) output to the driving coil (102′) thereby holding electrification for excitation; or the driving coil (102′) being supplied by higher voltage DC or AC power (VH) to be driven to a stable position or a selected position in the stroke of actuation is operatively controlled by the switching device (101) being operatively controlled by the position detector device (105) to be switched to allow the power source device with variable output voltage (100) to provide lower voltage DC or AC power (VL) to the driving coil (102′) thereby holding electrification for excitation;
The position detector device (105) can be constituted by pressure sensing type electromechanical switching devices or pressure-actuating spring leaf type switches, or can be constituted by optical, electromagnetic inducing type, capacitive inducing type or other conventional position sensing devices, wherein this device can be optionally installed or not installed as required.

4. The electromagnetic actuating device being actuated by high voltage and held electrification by low voltage as claimed in claim 1, wherein the AC surge absorption device (103), DC surge absorption device (113) or general type surge absorption device (123) being optionally installed to parallel connect with the driving coil based on input power types to the electromagnetic actuating device (102) is used to help absorbing the produced inductance of counter-electric potential in the driving coil (102′), when the driving coil (102′) is operated by the switching device (101) to open or close, or to receive higher voltage DC or AC power (VH) for electrifying the driving coil (102′), or to be switched to provide lower voltage DC or AC power (VL) output to the driving coil (102′) for holding excitation, wherein AC or DC power input to the driving coil (102′) can be respectively matchingly optionally connected with the AC surge absorption device (103), DC surge absorption device (113), or general type surge absorption device (123); wherein the surge absorption device is optionally constituted by the following:
(1) When the driving coil (102′) is powered by AC power, the AC surge absorption device (103) is installed, such as that it can be constituted by a bipolar solid state varistor, or constituted by at least two kinds of components of the resistors, inductors, bipolar capacitors, etc. in series connection, parallel connection, or series-parallel connection, or constituted by the bipolar capacitor alone, or constituted by other conventional AC surge absorption circuit devices; or
(2) When the driving coil (102′) is powered by DC power, DC the surge absorption device (113) is installed, such as that it can be constituted by reverse polarity diodes in parallel connection to appear a flywheel diode with energy storage effect, or constituted by at least two kinds of components of the resistors, inductors, uni-polar or bipolar capacitors in series connection, parallel connection, or series-parallel connection, or constituted by the uni-polar or bipolar capacitor alone, or constituted by the solid state varistor or other conventional DC surge absorption devices; or
(3) When the driving coil (102′) is powered by mixture of AC and DC power, the general type surge absorption device (123) capable of absorbing either AC surge power or DC surge power is installed, such as that it can be constituted by at least two kinds of components of the resistors, inductors or bipolar capacitors in series connection, parallel connection, or series-parallel connection, or constituted by the bipolar capacitor alone, or constituted by bipolar solid state varistor or other conventional general type surge absorption devices; wherein this device can be optionally installed or not installed as required.

5. The electromagnetic actuating device being actuated by high voltage and held electrification by low voltage as claimed in claim 1, wherein the electromagnetic actuating device installed with a DC or AC driving coil includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the power source device with variable output voltage is operatively controlled by the switching device to electrify driving coil of the electromagnetic actuating device by higher voltage power input to produce a larger electromagnetic actuating force on the electromagnetic actuating device.
